(19) United States
(12) Patent Application Publication
(10) Pub. No.: US 2015/0105130 A1
(43) Pub. Date: Apr. 16, 2015

(54) IMAGE MATCHING GAME

(71) Applicant: Embed Singapore Pte Ltd, Singapore (SG)

(72) Inventors: Christopher John McGrath, Highvale (AU); Shannon Perell, Lippo Karawaci- Tangerang (ID); Zachary William Duff, Brunswick (AU)

(21) Appl. No.: 14/510,760

(22) Filed: Oct. 9, 2014

Related U.S. Application Data
(60) Provisional application No. 61/889,221, filed on Oct. 10, 2013.

(51) Int. Cl. G07F 17/32

(52) U.S. Cl. CPC G07F 17/326; G07F 17/3211; G07F 17/3244
USPC 463/9

(57) ABSTRACT

An image matching game is described that provides multiple game display elements to a user. Each display element cycles through displaying one of a plurality of images. The user provides input to stop the changing display on one image. With each successive game display element, the user tries to stop the changing images on the same image as the previous display elements. When the user successfully stops the changing display elements and matching images across the game display elements, the user receives an indicia of reward. If the user fails to successfully match the image on any one element in the series of game display elements, the game turn either ends or the user loses one of a set number of attempts provided by the game. Depending on the implementation of the game, the user may receive interim level rewards for matching fewer than all of the game display elements.

### CROSS-REFERENCE TO RELATED APPLICATIONS

The present application claims priority to co-pending U.S. Provisional Patent Application No. 61/889,221, entitled “IMAGE MATCHING GAME,” filed Oct. 10, 2013, the disclosure of which is hereby incorporated herein by reference.

### BACKGROUND

1. Field

The present disclosure relates, in general, to amusement gaming, and, more particularly, to image matching games.

2. Background

Prize-dispensing arcade games, also known in the art as redemption arcade games, are popular entertainment machines that are commonly found in arcades, malls, theaters, restaurants, theme parks, and other locations with large concentrations of people. These machines typically display objects, such as stuffed animals, trinkets, electronic devices, and other desirable prizes, hanging from or affixed to mechanical arms or connectors inside a game cabinet or locked behind individually controlled doors and are clearly visible to those who pass by. Usually, these objects are offered as prizes to a player who wins or accomplishes some predetermined objective of the game. Typically, a player will insert a game credit, which may be some form of monetary credit, token, swiping of a game card, or the like to play the game. The player then plays the game and attempts to accomplish the predetermined objective in order to win the game. If the player is successful, a prize is typically immediately awarded to the player through a door or compartment in the game cabinet. When the objective is achieved, the game mechanism operates to release one of the prizes from the mechanical arm or connector to a chute or pathway that leads to this compartment in the game cabinet.

Other types of arcade games may offer a player an opportunity to play a game for one or more indicia of reward, such as tickets, tokens, credits, or the like. The player may then play several different types of games and accumulate the indicia of reward in order to exchange a number of such indicia for various prizes. These prizes are often housed at a central desk or location in the arcade where the player may view the selection of prizes and the cost in indicia for obtaining each prize. The player would exchange the appropriate number of indicia to a worker at the prize desk and obtain the desired prize. Other methods for redemption have been used, such as prize kiosks, which house the variety of prizes and allow the player a self-service process to turn in or submit the appropriate number of indicia to the kiosk mechanism or electronics and then select the desired prize using various types of user input interfaces. If the number of indicia submitted by the player is sufficient for the selected prize, the kiosk mechanism will release the prize to the user through a chute, hatch, or other such mechanisms.

Redemption arcade games are very popular with users who participate in various types and styles of games with varying game objectives and actions. It is beneficial to develop new game objectives and mechanisms that increase and maintain user interest and enjoyment.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

The various embodiments of the present teachings are directed to an image matching game which provides multiple game display elements to a user. The user provides input to stop the changing images on the same image as the image displayed on the previous display elements. The user would receive an indicia of reward when the user successfully stops the changing images in each game display element with matching images across each of the game display elements. If the user fails to match the image on any one element in the series of game display elements, the game turn ends. Alternatively, instead of ending, the player may lose one of a number of tries or “lives,” based on the particular game settings. The image change rate may become faster during the game play. The user may still receive interim level rewards for matching fewer than all of the game display elements.

In one aspect of the disclosure, a game method that includes displaying each image of a plurality of images onto a first segment of a plurality of segments of a game display, stopping the displaying onto the first segment in response to user input, displaying each image of the plurality of images onto a next segment of the plurality of segments, stopping the displaying onto the next segment in response to additional user input, in response to the set image matching the next set image, displaying each image of the plurality of images on a last segment of the plurality of segments, stopping the displaying onto the last segment in response to last user input, and in response to the last set image matching the next set image, providing an indicia of reward to a user. The first segment displays a set image of the plurality of images that was displayed on the first segment when the user input was detected. The next segment displays a next set image of the plurality of images that was displayed on the next segment when the additional user input was detected. The last segment displays a last set image of the plurality of images that was displayed on the last segment when the last user input was detected.

In additional aspect of the disclosure, a game apparatus that includes a game display configured to display each image of a plurality of images onto a first segment and a second segment of a plurality of segments of the game display, a game control configured to stop the displaying onto the first segment in response to user input and stop the displaying onto the next segment in response to additional user input, a processor configured to compare the next set image to the set image, and a reward device configured to provide an indicia of reward to a user in response to the last set image matching the next set image. The game display is further configured to display each image of the plurality of images on a last segment of the plurality of segments in response to the set image matching the next set image. The game control is further configured to stop the displaying onto the last segment in response to last user input.

In additional aspect of the disclosure, a game apparatus that includes means for displaying each image of a plurality of images onto a first segment of a plurality of segments of a game display, means, executable in response to user input, for stopping the displaying onto the first segment, means for displaying each image of the plurality of images onto a next segment of the plurality of segments, means, executable in response to additional user input, for stopping the displaying onto the next segment, means, executable in response to the set image matching the next set image, for displaying each image of the plurality of images on a last segment of the plurality of segments, means, executable in response to last user input, for stopping the displaying onto the last segment, and means, executable in response to the last set image matching the next set image, for providing an indicia of reward to a user.

In additional aspect of the disclosure, a game method that includes receiving user input to sequentially select an image from a plurality of images for each element of a set of display elements, comparing, after each user input, one or more selected images to a pre-defined image sequence, and providing an indicia of reward to a user in response to the one or more selected images matching the pre-defined image sequence. Each element of the set of display elements cyclically displays each of the plurality of images at an image display rate.

### BRIEF DESCRIPTION OF THE DRAWINGS

FIGS. 1A-1C are block diagrams illustrating image matching redemption games configured according to one aspect of the present disclosure.

FIGS. 2A-2H are block diagrams illustrating progressive game play of an image matching game configured according to one aspect of the present disclosure.

FIGS. 3A-3F are block diagrams illustrating an image matching game configured according to one aspect of the present disclosure.

FIGS. 4A-4F are block diagrams illustrating an image matching game configured according to one aspect of the present disclosure.

FIG. 5 is a functional block diagram illustrating example blocks executed to implement one aspect of the present disclosure.

FIG. 6 is a functional block diagram illustrating example blocks executed to implement one aspect of the present disclosure.

### DETAILED DESCRIPTION

One interesting approach to game entertainment is to provide fair opportunities for users to win a game using observation and reflexes. By tapping into the visual and physical reflexes, a user can be entertained and develop skill in winning the game objective. Various embodiments of the present disclosure are directed to games in which the user or player watches for a series of images that change over time at varying rates and then selects to stop the changing sequence to match successive images. For example, a series of three, four, five, or more display squares positioned side-by-side may sequentially change colors. Using a button or touchscreen location, the user stops the changing to set each display square at a certain color. The user stops the color changing on each display square in sequence. The objective for the user is to stop the changing in each square to match the colors in the entire collection of display squares. If the user successfully stops the changing in each square so that the ending colors in the squares match, then the game provides some reward or indicia of a reward to the user.

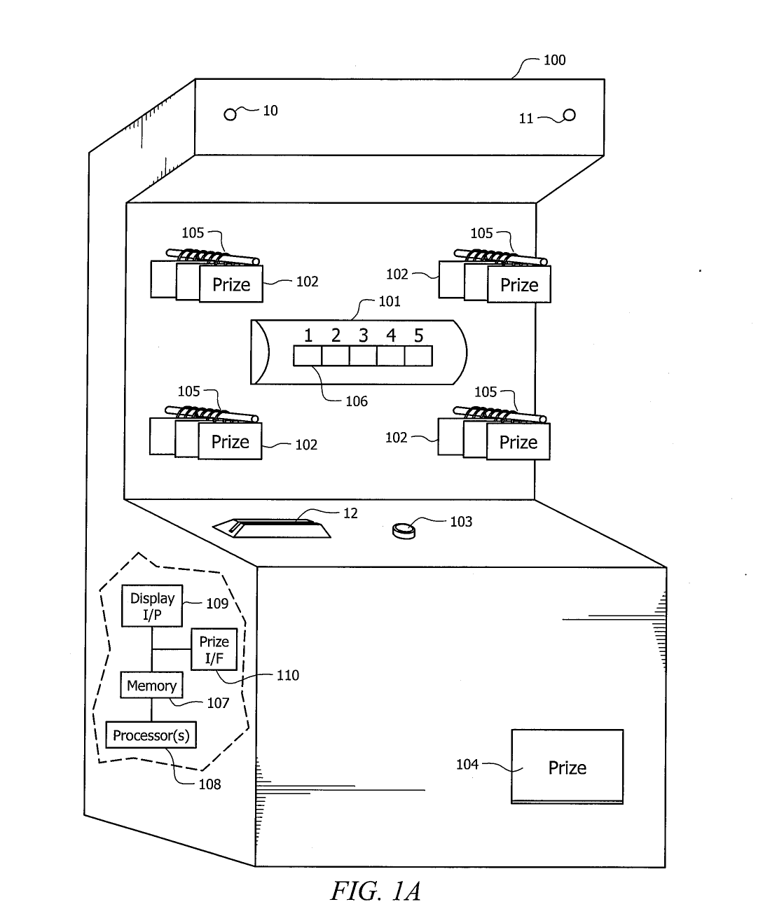

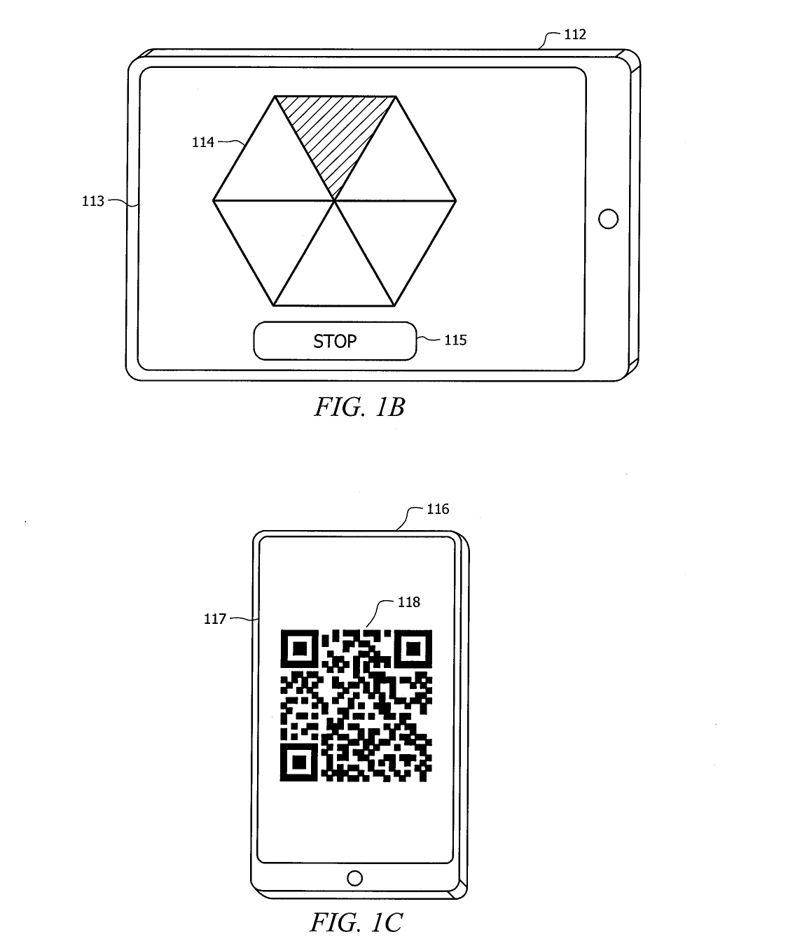

FIG. 1A is a block diagram illustrating a game cabinet 100 housing a redemption game configured according to one aspect of the present disclosure. Game cabinet 100 includes an electronic display 101, which presents game display elements 106-1-106-5 to a user. A variety of prizes 102 are hung on prize arms 105. By interacting with the game through game control 103, the user may play the game and, if successful, one of prizes 102 may be released from one of prize arms 105 into a prize dispensing area 104. One or more electronics displays 101 may be implemented on game cabinet 100. Alternatively, game cabinet 100 may include a mechanical or colored lamp display instead of electronic display 101 or both electronic display 101 and the mechanical display or colored lamp display.

The game mechanism is generally controlled through one or more processors, such as processor(s) 108, which execute game and prize-dispensing logic stored in memory 107. Memory 107 may be various types or combinations of types of disk or solid-state memory types, such as random access memory (RAM), read only memory (ROM), flash memory, or the like. The logic stored in memory 108 executed by processor(s) 107 control the content displayed by electronic display 101 onto game display elements 106-1-106-5 and manipulate the content of the game display by receiving input from the user through game control 103. Processor(s) 108 interact with these components through display interface 109. When the user achieves the required game objective, processor(s) 108 execute prize-dispensing logic through prize interface 110 in order to release one of prizes 102 from the corresponding one of prize arms 105. Safeguards in the game and prize-dispensing logic as well as physical safeguards built into prize arms 105 and game cabinet 100 assist to prevent a user from obtaining either game play without exchanging an appropriate game play credit or prize retrieval without having first successfully achieved the game objective that entitles the user to a prize.

In one embodiment of the present disclosure, the game logic provides a color matching game to the user. After a user exchanges the required game play credit to begin playing the game, game display element 106-1 begins displaying and changing colors over time. The color change may occur nearly instantaneously with game display element 106-1 seeming to instantly change from a first color to a second color after a predetermined amount of time. Alternatively, the first color may fade, morph, or rotate into the second color through different types of motion in which game display element 106-1 is only completely at the first color for a certain period of time and then begins to display parts of both the first and second colors gradually until the entirety of game display element 106-1 shows the second color.

The user observes the changing of colors on game display element 106-1 and, using game control 103, selects to stop the changing to set game display element 106-1 on a single color. As the user selects to stop game display element 106-1 on the first color, game display element 106-2 begins to cycle through colors with various changing colors being presented to the user. The objective of the game in the presently described example is for the user to observe the changing colors in game display element 106-2 and, using game control 103, stop the changing when the color displayed on game display element 106-2 matches the color stopped on game display element 106-1. If the user fails to stop the changing colors on game display element 106-2 on the matching color, the user does not meet the game objective and the game either ends or begins again, depending on how game retries are handled in the particular installation of game cabinet 100. However, if the user successfully stops the changing colors on game display element 106-2 on a color matching the color on game display element 106-1, the game continues with changing colors being displayed to the user on game display element 106-3.

It should be noted that, in various embodiments of the present disclosure, as the user successfully matches game display elements, the rate of color changing mostly increases for the subsequent game display elements to increase the difficulty of the game. For example, colors may change every 2 seconds on game display element 106-1, while, if the user makes it to game display element 106-5, colors may change every 0.25 seconds on game display element 106-5. The faster rate of change increases the challenge for the user to successfully achieve the objective of the game and increases the enjoyment and determination of the user to play. Alternatively, the rate of color changing may also be constant during the game.

It should further be noted that, in various embodiments of the present disclosure, should the user fail to accurately match game display elements, the game may send the user back either to the beginning or a certain number of steps, such that the user would be required to restart the matching procedure from the point at which the game sends the user back after the mismatch.

It should further be noted that, in various additional embodiments of the present disclosure, should the user fail to accurately match game display elements, the game continues and allows the user to continue attempting to match, either the new color or the previous color. In such alternative aspects, the game would determine a particular indicia of reward based on the number of matches out of the entire possible set of matches.

As the user continues to successfully stop the changing colors to match the previous game display elements, the game continues until all of game display elements 106-1-106-5 match with the same color or the user fails to match one. If the user fails to match any color, the game ends as described above. However, if the user successfully matches all of the colors on game display elements 106-1-106-5, the user will be entitled to one of prizes 102. Depending on the implementation of the game, the user may select a particular one of prizes 102 or the prize selection may be predetermined, in which case, upon successfully achieving the game objective, processor(s) 108 executes prize-dispensing logic through prize interface 110 to cause the corresponding one of prize arms 105 to release the designated prize 102. Whichever prize dispensing implementation is used, the user may then retrieve the dispensed prize from prize dispensing area 104.

It should be noted that the prize dispensing mechanism may be associated with the length of play of a user at game cabinet 100. If a user continues to play multiple game plays at game cabinet 100, prize dispensing logic stored in memory 108 tracks the number of successive plays by the same user. In select embodiments of the present disclosure, biometric information may be observed using biometric sensors 10 and 11 or player-specific information may be retrieved from a player card using card reader 12 or any other readable identification medium in order to determine that the same player is playing multiple game plays at game cabinet 100. As the number of successive game plays continue, the prize dispensing logic increases the value of the prize that the user may be eligible for. If the user wins at a first game play, a first prize having a lower value may be awarded. If the user has been playing multiple games at game cabinet 100, the prize dispensing logic may designate a higher value prize that the user may win on successfully achieving the game objective. Various types of prize systems may be used by the different alternative embodiments of the present disclosure. Thus, prizes 102 may embody a variety of different prizes each having a different value. As the number of successive game plays continue, the difficulty level of the game play may also increase.

The various embodiments of the present disclosure are not limited only to free-standing game cabinets that are placed in gaming arcade locations. Additional embodiments of the present disclosure may be provided on different types of devices. FIG. 1B is a block diagram illustrating a table computer 112 configured to provide an image matching game according to one embodiment of the present disclosure. Tablet computer 112 includes a display 113, that displays game display wheel 114 to a user. Tablet computer 112 includes an image matching game application (not shown) in memory that, when executed by the processor (not shown) of tablet computer 112, presents the image matching game to the user. The executing image matching game displays game display wheel 114 that include multiple segments. A game control button 115 is also presented on display 113. Display 113 incorporates touchscreen capabilities, so that, by interacting with display 113, the user may manipulate the game. The user may use the game control button 115 to stop the changing of the image on each of the segments of game display wheel 114 in order to play the game.

The image matching game operated on tablet computer 112 may be provided by an arcade operator to a user at the arcade. For example, the arcade operator may maintain multiple tablet computers that are available to users to take with them as they visit the arcade. Between playing other free-standing arcade games, the users may also play the games, including the image matching game, on the tablet computer, such as tablet computer 112, provided by the arcade operator. The executing game logic on tablet computer 112 keeps track of any points, token, credits, or other such indicia of reward that the user wins when playing the game and, when the user returns tablet computer 112, the arcade operator reads the total number of indicia available to the user and allows the user to select a corresponding prize or to get a monetary reward. Alternatively, the user may obtain a record of the number of indicia won during play on tablet computer 112 to keep and save up for a higher valued prize. Such indicia of reward may also include a score or number value indicating a level which the user have achieved. Such a record may be implemented using a receipt, physical tokens or tickets, the value electronically, optically, graphically, or magnetically recorded on a player card, or the like.

In additional embodiments of the present disclosure, an arcade operator may provide the gaming application for the image matching game for a user to download to a personally owned tablet computer, such as tablet computer 112. In such embodiments, the user could play the image matching game on his or her personal tablet computer and transmit the resulting number of indicia to the game operator using various wireless means, such as email, direct ad hoc wireless transmission, text message, or the like.

FIG. 1C is a block diagram illustrating a mobile device 116 configured to operate an image matching game configured according to one aspect of the present disclosure. Similar to the image matching game application available for execution and play on tablet computer 112, as described with respect to FIG. 1B, an image matching game application configured according to one aspect of the present disclosure may also be presented for download and play to mobile device 116. Mobile device 116 may be any type of person electronic device, such as a mobile phone, smart phone, electronic video display, electronic reader, electronic music player, or the like. Each of these various types of mobile device 116 provides for wireless communication facilities using various available wireless technologies, such as wireless wide area network (WWAN) and wireless local area network (WLAN) communication technologies or other wireless communication networks.

Mobile device 116 includes display 117 which may be configured for touchscreen capabilities in order to receive input from the user through direct manipulation of display 117. After downloading the image matching game application to mobile device 116, the user may play the image matching game configured according to the various aspects provided in this disclosure. The arcade or game application owner may provide locations where the user may go to redeem any indicia of reward won by playing games, such as the image matching game application. In one aspect for redeeming the indicia, the operating image matching game application generates an optical code, such as optical code 118, and displays optical code 118 on display 117. Through interaction with an optical code reader (not shown) at the game redemption location, the user may transfer the game play data, including the number of indicia won by the user for redeeming a prize.

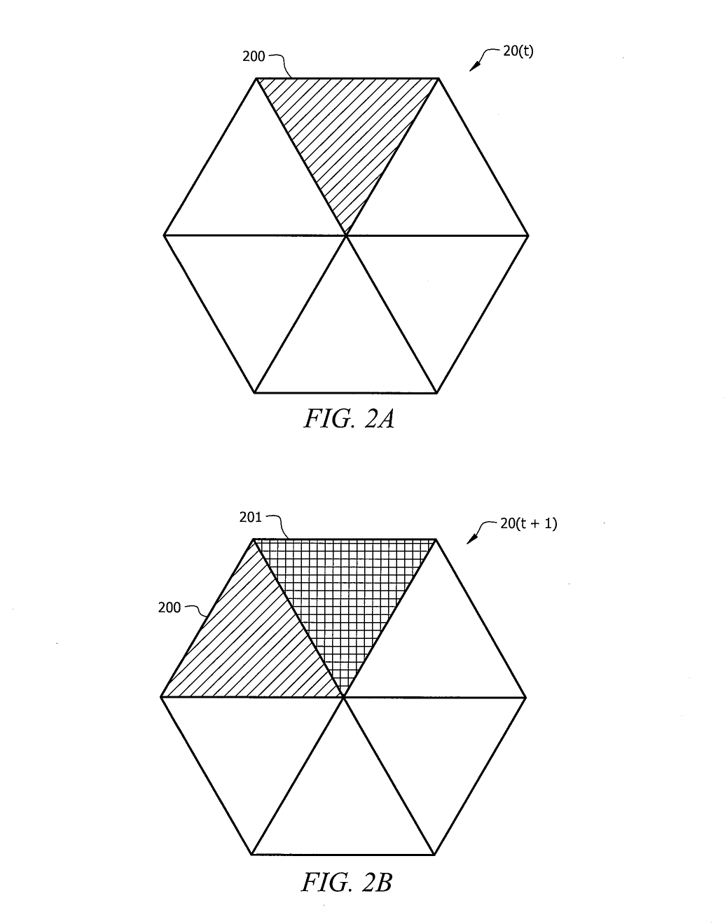

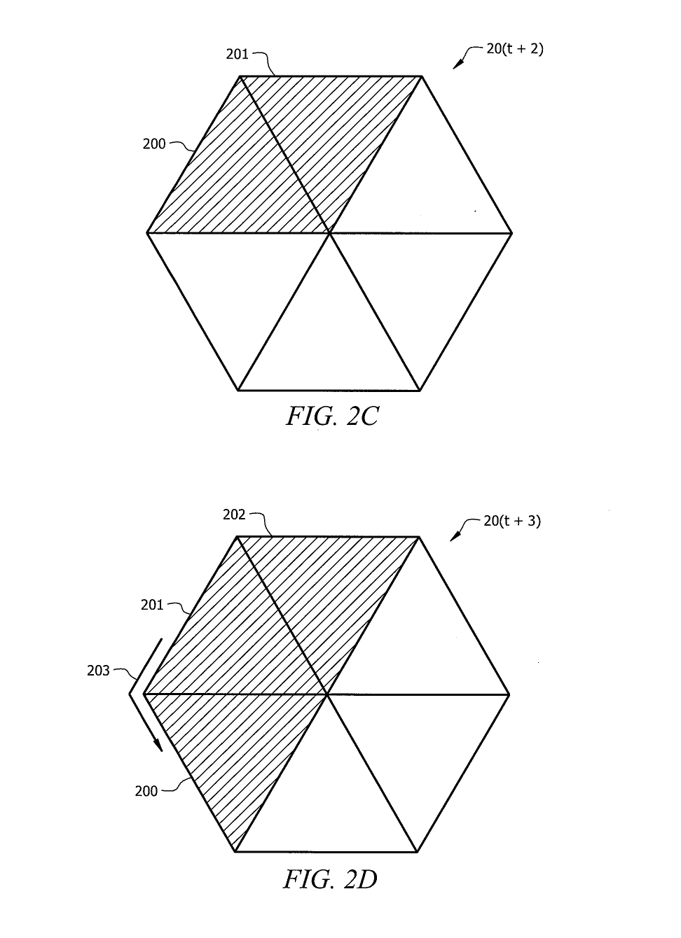

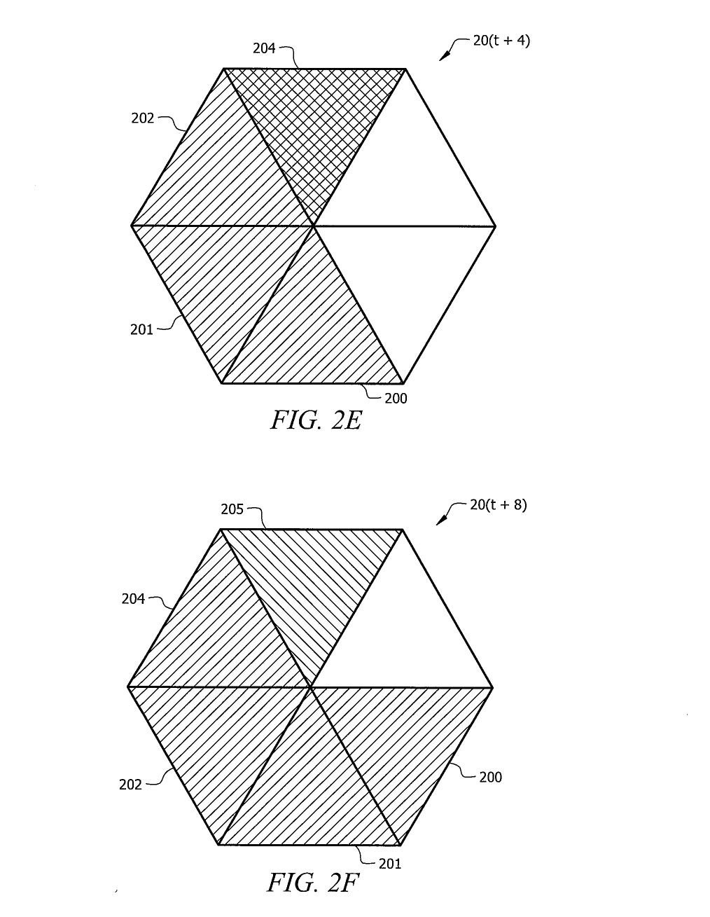

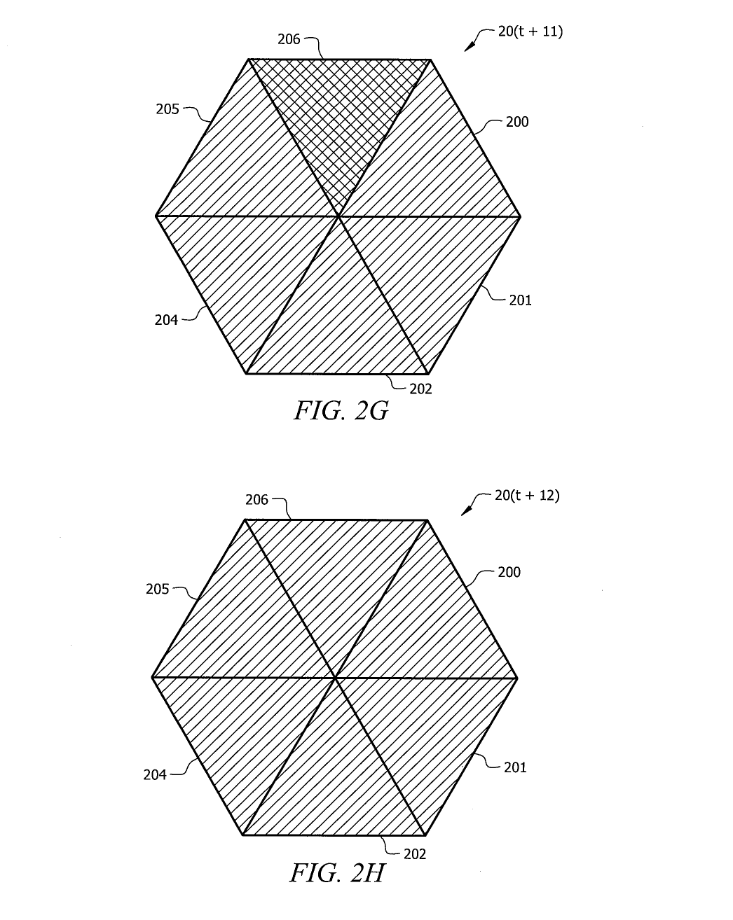

Turning now to FIGS. 2A-2H, block diagrams are shown illustrating the progressive game play of an image matching game configured according to one aspect of the present disclosure. At FIG. 2A game display wheel 20 is shown at time, t. At time, t, the user has stopped the colors changing in segment 200 at a first color. FIG. 2B shows game display wheel 20 at time, t+1. At time, t+1, segment 200 has rotated over and now colors are shown changing in segment 201 of game display wheel 20. As illustrated in FIG. 2B, a different color is displayed than displayed in segment 200. If the user were to stop the color changing at time, t+1, the game objective would be lost.

FIG. 2C shows game display wheel 20 at time, t+2. At time, t+2, the color in segment 201 has changed to the same color as displayed in segment 200 of game display wheel 20. If the user selects to stop the color changing in segment 201 at time, t+2, the colors in segments 200 and 201 will match, allowing the user to continue playing the game. FIG. 2D illustrates the color changing now occurring at segment 202, game display wheel 20 continues to rotate in direction 203 as the user successfully stops the color changing to match colors in successive game display segments. At time, t+3, the color illustrated in segment 202 matches the colors set in segments 200 and 201. If the user selects to stop the color changing in segment 202 at time, t+3, colors in segments 200-202 will match, again, allowing the user to continue playing the game.

FIG. 2E shows game display wheel at time, t+4. At time, t+4, the color changing in the next segment rotated over in game display wheel, segment 204, displays another color that is different than the colors set in segments 200-202. The color displayed in segment 204 If the user were to stop the color changing at time, t+4, the user would lose the game, as the color displayed in segment 204 does not match the colors set in segments 200-202. FIG. 2F shows game display wheel at time, t+8. The user successfully selected to stop the color changing at segment 204 to match the color set in segments 200-202. As illustrated in FIG. 2F, the colors changing in segment 205 shows a different color than the colors set in segments 200-202 and 204. If the user were to stop the color at time, t+8, the user would lose the game. By segment 205, the colors may be changing at a faster rate than they were changing during segment 200. As the user gets closer to winning the game, the challenge of successfully stopping the changing at the right instant becomes more difficult.

After successfully matching the color in segment 205, the final segment, segment 206, begins the color changing, as illustrated in FIG. 2G, at time, t+11. Multiple color changes may have occurred between time, t+8 (FIG. 2F) and t+11. The color now displayed in segment 206 is different than the colors of the other segments 200-202 and 204-205. Additionally, the rate of change of the colors in segment 206 may be even more rapid than that implemented for segment 205, thus, making the operation of matching the color in segment 206 very challenging to the user. FIG. 2H shows game display wheel 20 at time, t+12. At time, t+12, the user has successfully stopped the color changing in segment 206 to match all of segments 200-202 and 204-205. By matching all of segments 200-202 and 204-206 of game display wheel 20, the user achieves the final objective of the image matching game and is rewarded with a prize or indicia of reward that may be accumulated for a prize.

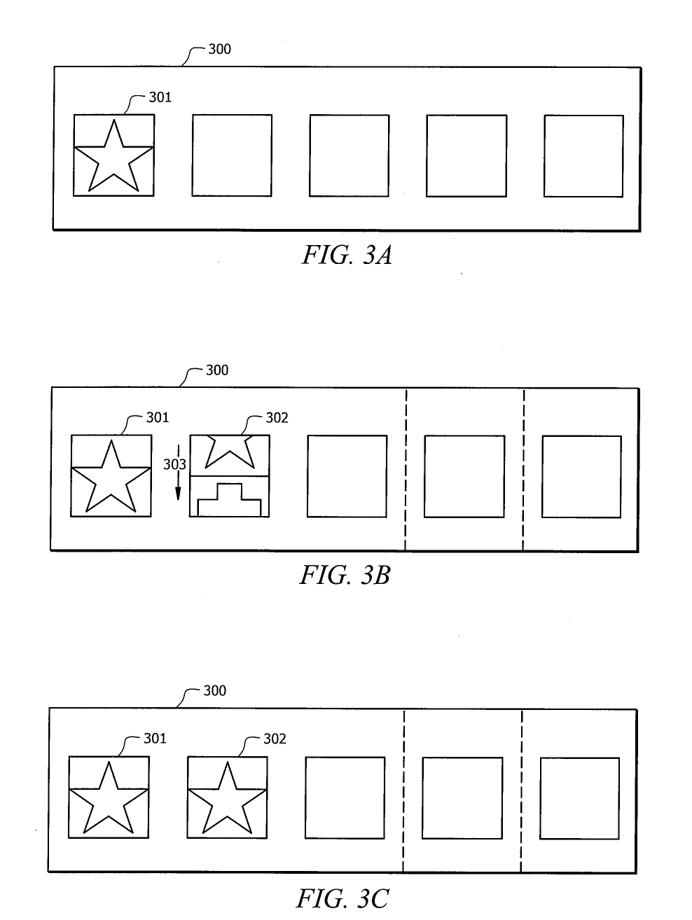

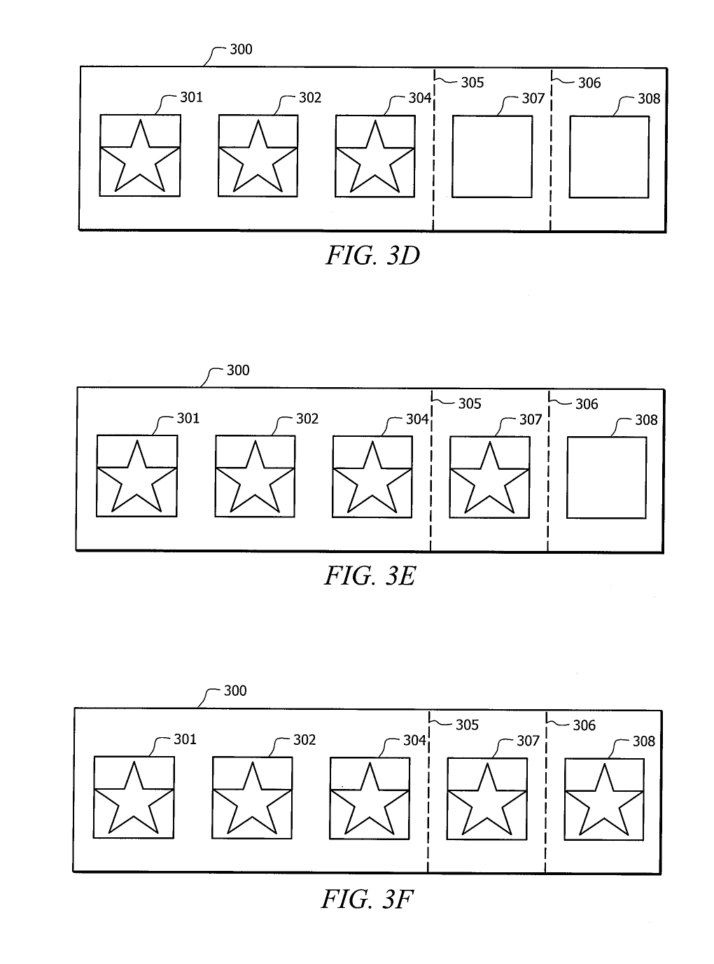

It should be noted that while several example embodiments of the present disclosure have been explained using color matching for the image matching games, other images may be used. FIGS. 3A-3F are block diagrams illustrating an image matching game 300 configured according to one aspect of the present disclosure. Image matching game 300 includes a series of five game display segments. During game play, various images are displayed and changed in each of the game display segments. The object of the game is for the use to stop the changing of images in each display segment in order to match the images across the five game display segments.

As the user begins play of image matching game 300 in FIG. 3A, images start changing in game segment 301. As the user stops the changing in game segment 301, a star is displayed. FIG. 3B shows the images changing in game segment 302. The initially displayed image of a cross is gradually changing to a star as the images scroll down in direction 303. If the user were to stop the changing at this instant, when the images have not yet fully changed, the user would lose the game objective and the game would be over or available for replay. The user carefully observes the movement of the changing images in order to capture the instant that the star image is fully displayed in segment 302 in order to match the star image set in segment 301, as shown in FIG. 3C. Images in game display segments may also instantly change from one image to the next.

FIG. 3D shows the user having successfully set matching star images in segments 301, 302, and 304. The embodiment of the present disclosure illustrated in FIGS. 3A-3F include an additional feature that provide multiple prize winning opportunities for the user. For example, the skill required in matching segments 301, 302, and 304 may not be extremely challenging. However, minor prize line 305 indicates to the user that if he or she successfully matches images in segment 307 to the images set in segments 301, 302, and 304, then the user will be eligible for a minor prize having a first value. Major prize line 306 indicates to the user that if she or she successfully matches images in segment 308 to the images set in segments 301, 302, 304, and 307, that the user will win a major prize having another value higher than the minor prize value.

FIG. 3E shows the user has matched star images in each of segments 301, 302, 304, and 307, having surpassed minor prize line 305. Thus, if the user fails to match the image in segment 308 to the star image set in segments 301, 302, 304, and 307, the user would still win the minor prize, but not achieve the level of success to be guaranteed the major prize. Alternatively, the user may be either awarded the minor prize irrespective of whether the user fails to match the image in segment 308 or whether the user continues the game play or asked to choose to either take the minor prize and finish the game or risk losing the game to play for the major prize. At FIG. 3F, image matching game 300 is shown where the user has successfully matched the star image in each of segments 301, 302, 304, 307, and 308, thus, winning the major prize after surpassing major prize line 306. Upon successful completion of the game, the user would either gather the major prize as dispensed at the game machine operating image matching game 300 or would have an indicia of the prize that he or she could redeem for the major prize at a different location.

In additional embodiments of the present disclosure, a mixture of colors and images for the image matching games may also be used. For example, in the color matching game illustrated in FIGS. 2A-2G, if a special image rather than a color is matched in one or more segments and all the colors and special image are matched, a super or a special prize may be rewarded. Alternatively, the user may be required to match the special image in all segments in order to win the super or special prize. The special image may be a brand logo. The special prize may be a branded prize. Alternatively, in the image matching game illustrated in FIGS. 3A-3F, if a special color rather than an image is matched in one or more segments and all the images and special color are matched, a super or a special prize may also be rewarded. There may be a difference between the image and color change rates. The image change rate of the special image may be faster or slower than the color change rate. In some embodiments, the image change rate of the special image may depend on the value of the super or special prize. For example, if the value of the super or special prize is higher than the value of a normal prize for color matching, the image change rate of the special image may be faster than the color change rate.

It should be noted that the image matching game may be configured to have more than just two prize levels. Various levels may be set among the game display elements that provide for increasing value of the available prize the more matches that the user can successfully make.

It should also be noted that the number of segments used with an image matching game may vary. The shape of each segment and the arrangement of segments may also vary. A segment shape may include, but not limited to, a square, a circle, an octagon, a triangle, a hexagon, a rectangle, and a pre-defined shape. A layout of segments may include, but not limited to, one or more horizontal lines of segments, circular segments, and a pre-defined arrangement.

In additional embodiments of the present disclosure, one or more additional display elements may be added to game cabinet 100 (not shown in Figures). The user may stop changing images on the additional display element to match images displayed on the entire or partial series of display elements 106-1˜106-5 to win a special prize.

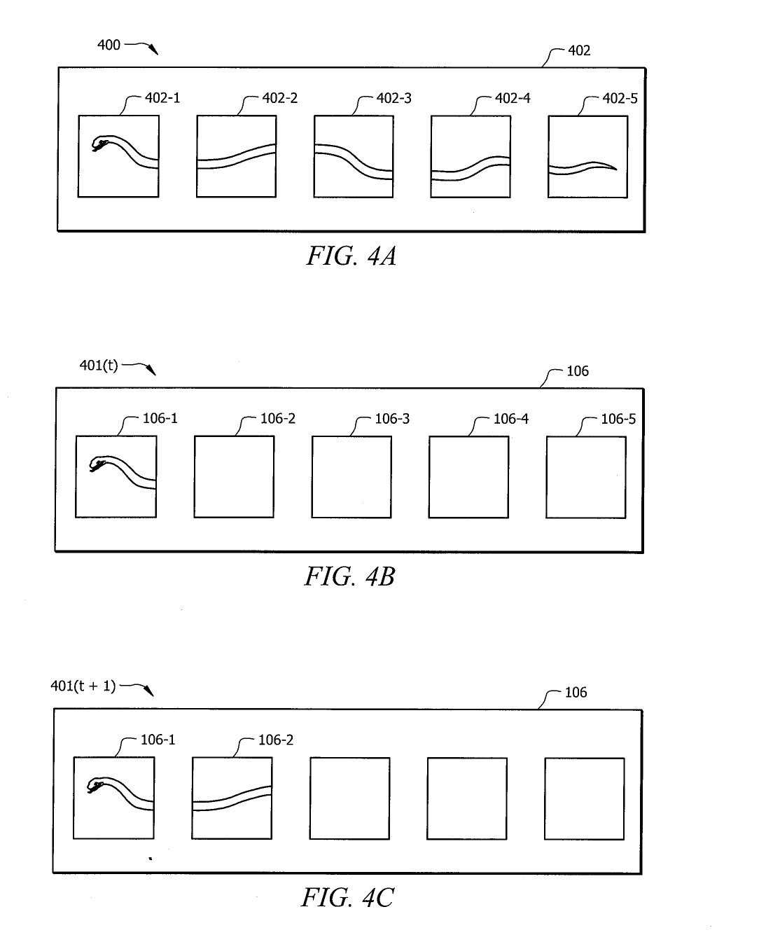

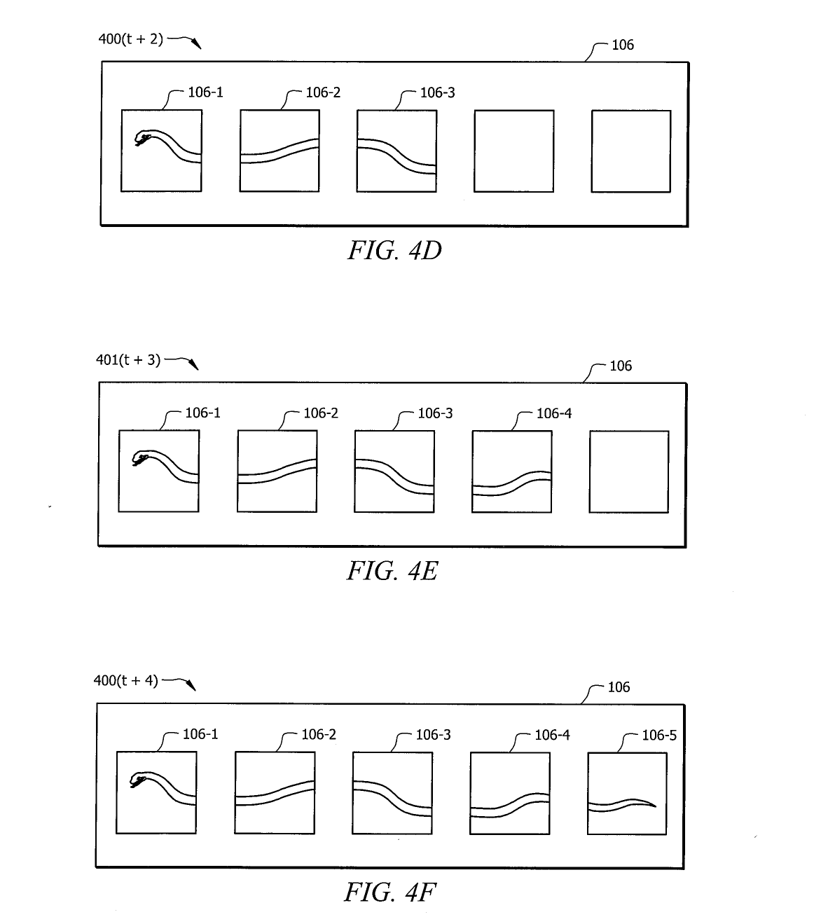

FIGS. 4A-4F are block diagrams illustrating an image matching game implemented on game cabinet 100, as illustrated in FIG. 1A, according to one aspect of the present disclosure. FIG. 4A shows that pre-defined sequence 400, forming a picture of snake, is separated into five segments and displayed on image segments 402-1, 402-2, 402-3, 402-4, and 402-5 of target display 402. The object of the game is for the user to sequentially stop the changing of images in a series of display elements 106-1, 106-2, 106-3, 106-4, and 106-5 in order to match pre-defined image sequence 400 displayed on target display 402. FIGS. 4B-4F show that the user sequentially selects images in display elements 106-1-106-5 at times t, t+1, t+2, t+3, and t+4. In FIG. 4B, the user successfully chooses the snake head image at time, t. FIGS. 4C-4F show that the user successfully chooses the snake body images at times, t+1, t+2, t+3, t+4. The time interval between each image selection may be varied. The period of time of displaying pre-defined image sequence 400 on target display 402 may be adjustable. It will be more challenging for the user if pre-defined image sequence 400 is hidden during the game. In additional embodiments of the present disclosure, pre-defined image sequence 400 may be temporality displayed on the series of display elements 106-1, 106-2, 106-3, 106-4, and 106-5 before start of the matching game.

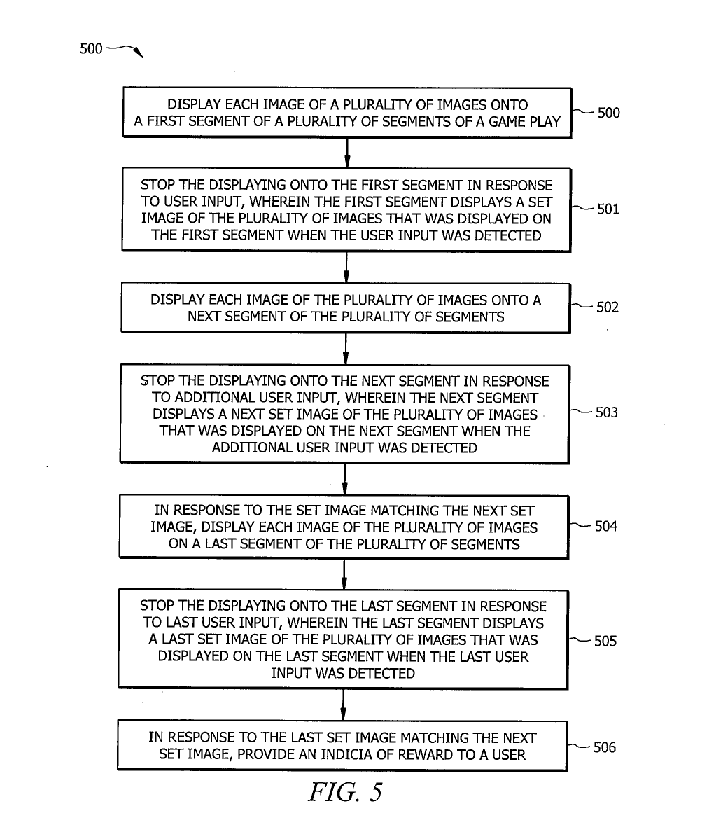

FIG. 5 is a functional block diagram illustrating example blocks executed to implement one aspect of the present disclosure. In block 500, each image of a plurality of images may be displayed onto a first segment of a plurality of segments of a game play. In block 501, the displaying may be stopped onto the first segment in response to user input. The first segment displays a set image of the plurality of images that was displayed on the first segment when the user input was detected. In block 502, each image of the plurality of images may be displayed onto a next segment of the plurality of segments. In block 503, the displaying may be stopped onto the next segment in response to additional user input. The next segment displays a next set image of the plurality of images that was displayed on the next segment when the additional user input was detected. In block 504, each image of the plurality of images may be displayed on a last segment of the plurality of segments in response to the set image matching the next set image. In block 505, the displaying may be stopped onto the last segment in response to last user input. The last segment displays a last set image of the plurality of images that was displayed on the last segment when the last user input was detected. In block 506, an indicia of reward may be provided to a user in response to the last set image matching the next set image.

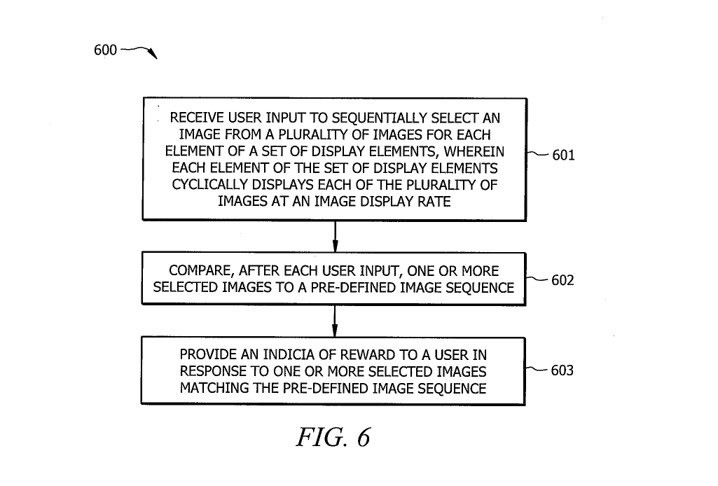

FIG. 6 is a functional block diagram illustrating example blocks executed to implement a game method 600 according to one aspect of the present disclosure. The game method 600 may be implemented on various devices including, but not limited to, a computer, a tablet computer, a mobile computer, a smart television, and a game machine described with reference to FIGS. 1A-1C. In block 601, a user input to sequentially select an image from a plurality of images for each element of a set of display elements may be received. Each element of the set of display elements may cyclically display each of the plurality of images at an image display rate. In block 602, after each user input, one or more selected images may be compared to a pre-defined image sequence. In block 603, an indicia of reward may be provided to a user in response to the one or more selected images matching the pre-defined image sequence. The pre-defined image sequence may include matching images or an image including one or more distinct image segment, each of which corresponds to an associated one of the set of display elements. The distinct image segment may include, but not limited to a color, a symbol, a picture, a graphical image, and a shape. In some embodiments, the number of matches between the one or more selected image and the pre-defined image sequence may be calculated. The number of matches between the one or more selected images and the pre-defined image sequence may correspond to an image display rate or the value of the indicia of reward.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The functional blocks and modules in FIGS. 5-6 may comprise processors, electronics devices, hardware devices, electronics components, logical circuits, memories, software codes, firmware codes, etc., or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. A computer-readable storage medium may be any available media that can be accessed by a general purpose or special purpose computer. By way of example, and not limitation, such computer-readable storage media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, non-transitory connections may properly be included within the definition of computer-readable medium. For example, if the instructions are transmitted from a website, server, or other remote source using a coaxial cable, fiber optic cable, twisted pair, or digital subscriber line (DSL), then the coaxial cable, fiber optic cable, twisted pair, or DSL are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

1. A game method, comprising:
displaying each image of a plurality of images onto a first segment of a plurality of segments of a game display;
stopping the displaying onto the first segment in response to user input, wherein the first segment displays a set image of the plurality of images that was displayed on the first segment when the user input was detected;
displaying each image of the plurality of images onto a next segment of the plurality of segments;
stopping the displaying onto the next segment in response to additional user input, wherein the next segment displays a next set image of the plurality of images that was displayed on the next segment when the additional user input was detected;
in response to the set image matching the next set image, displaying each image of the plurality of images on a last segment of the plurality of segments;
stopping the displaying onto the last segment in response to last user input, wherein the last segment displays a last set image of the plurality of images that was displayed on the last segment when the last user input was detected; and
in response to the last set image matching the next set image, providing an indicia of reward to a user.

2. The game method of claim 1, wherein the plurality of images comprise one or more of:
a plurality of colors;
a plurality of graphical images;
a plurality of shapes; and
a plurality of pictures.

3. The game method of claim 1, wherein a change in display of each image occurs at an image change rate.

4. The game method of claim 3, wherein the image change rate becomes faster for each segment of the plurality of segments after the first segment.

5. The game method of claim 1, further comprising:
in response to the last set image not matching the next set image providing an indicia of interim reward value associated with a number of matching segments between set images displayed on two of the plurality of segments and on each of the plurality of segments except for the last segment.

6. The game method of claim 1, wherein the indicia of reward comprises one or more of:
a prize;
a physical indicia indicating a reward value;
an optical indicia indicating the reward value;
an electronic indicia indicating the reward value;
a magnetic indicia indicating the reward value;
a graphical indicia indicating the reward value;
a monetary reward; and
a score or number value indicating a level achieved.

7. The game method of claim 1, wherein a value of the indicia of reward corresponds to a number of repeat games played by the user.

8. The game method of claim 7, further comprising:
obtaining game play data indicative of the number of repeat games played by the user.

9. The game method of claim 8, wherein the obtaining comprises one or more of:
obtaining biometric information determinative of the game play data; and
obtaining user identification information from a player card or a readable identification medium in possession of the user.

10. The game method of claim 1, wherein the method is performed on one or more of:
a game machine;
a computer;
a mobile phone;
a tablet computer;
a mobile computer; and
a smart television.

11. A game apparatus, comprising:
a game display configured to display each image of a plurality of images onto a first segment and a second segment of a plurality of segments of the game display;
a game control configured to stop the displaying onto the first segment in response to user input and stop the displaying onto the next segment in response to additional user input, wherein the first segment displays a set image of the plurality of images that was displayed on the first segment when the user input was detected, wherein the next segment displays a next set image of the plurality of images that was displayed on the next segment when the additional user input was detected;
a processor configured to compare the next set image to the set image;
the game display further configured to display each image of the plurality of images on a last segment of the plurality of segments in response to the set image matching the next set image;
the game control further configured to stop the displaying onto the last segment in response to last user input, wherein the last segment displays a last set image of the plurality of images that was displayed on the last segment when the last user input was detected; and
a reward device configured to provide an indicia of reward to a user in response to the last set image matching the next set image.

12. The game apparatus of claim 11, wherein the plurality of images comprise one or more of:
a plurality of colors;
a plurality of graphical images;
a plurality of shapes; and
a plurality of pictures.

13. The game apparatus of claim 11, wherein a change in display of each image occurs at an image change rate.

14. The game apparatus of claim 13, wherein the image change rate becomes faster for each segment of the plurality of segments after the first segment.

15. The game apparatus of claim 11, wherein the reward device is further configured to provide an indicia of interim reward value associated with a number of matching segments between set images displayed on two of the plurality of segments and on each of the plurality of segments except for the last segment in response to the last set image not matching the next set image.

16. The game apparatus of claim 11, wherein the indicia of reward comprises one or more of:
a prize;
a physical indicia indicating a reward value;
an optical indicia indicating the reward value;
an electronic indicia indicating the reward value;
a magnetic indicia indicating the reward value;
a graphical indicia indicating the reward value;
a monetary reward; and
a score or number value indicating a level achieved.

17. The game apparatus of claim 11, wherein a value of the indicia of reward corresponds to one of:
a number of repeat games played by the user;
a number of correct matches between the last set image and the next set image during display of each image of the plurality of images onto the plurality of segments of the game display.

18. The game apparatus of claim 17, further comprising:
a user identification device to obtain game play data indicative of the number of repeat games played by the user.

19. The game apparatus of claim 18, wherein the user identification device is further configured to:
obtain biometric information determinative of the game play data; and
obtain user identification information from a player card or a readable identification medium in possession of the user.

20. The game apparatus of claim 14, wherein the apparatus is one or more of:
a game machine;
a computer;
a mobile phone;
a tablet computer;
a mobile computer; and
a smart television.

21. A game apparatus, comprising:
means for displaying each image of a plurality of images onto a first segment of a plurality of segments of a game display;
means, executable in response to user input, for stopping the displaying onto the first segment, wherein the first segment displays a set image of the plurality of images that was displayed on the first segment when the user input was detected;
means for displaying each image of the plurality of images onto a next segment of the plurality of segments;
means, executable in response to additional user input, for stopping the displaying onto the next segment, wherein the next segment displays a next set image of the plurality of images that was displayed on the next segment when the additional user input was detected;
means, executable in response to the set image matching the next set image, for displaying each image of the plurality of images on a last segment of the plurality of segments;
means, executable in response to last user input, for stopping the displaying onto the last segment, wherein the last segment displays a last set image of the plurality of images that was displayed on the last segment when the last user input was detected; and
means, executable in response to the last set image matching the next set image, for providing an indicia of reward to a user.

22. The game apparatus of claim 21, wherein a change in display of each image occurs at an image change rate.

23. The game apparatus of claim 22, wherein the image change rate becomes faster for each segment of the plurality of segments after the first segment.

24. The game apparatus of claim 21, further comprising:
means, executable in response to the last set image not matching the next set image, for providing an indicia of interim reward value associated with a number of matching segments between set images displayed on two of the plurality of segments and on each of the plurality of segments except for the last segment.

25. The game apparatus of claim 21, wherein a value of the indicia of reward corresponds to one of:
a number of repeat games played by the user;
a number of correct matches between the last set image and the next set image during display of each image of the plurality of images onto the plurality of segments of the game display.

26. The game apparatus of claim 25, further comprising:
means for obtaining game play data indicative of the number of repeat games played by the user.

27. The game apparatus of claim 26, wherein the means for obtaining game play data includes means for obtaining biometric information determinative of the game play data and means for obtaining user identification information from a player card or a readable identification medium in possession of the user.

28. A game method, comprising:
receiving user input to sequentially select an image from a plurality of images for each element of a set of display elements, wherein each element of the set of display elements cyclically displays each of the plurality of images at an image display rate;
comparing, after each user input, one or more selected images to a pre-defined image sequence; and
providing an indicia of reward to a user in response to the one or more selected images matching the pre-defined image sequence.

29. The game method of claim 28, wherein the pre-defined image sequence comprises one of:
matching images; and
an image comprising one or more distinct image segments, wherein each of the one or more distinct image segments corresponds to an associated one of the set of display elements.

30. The game method of claim 28, further comprising:
calculating the number of matches between the one or more selected image and the pre-defined image sequence, wherein the number of matches between the one or more selected images and the pre-defined image sequence corresponds to one or more of:
the image display rate; and
the value of the indicia of reward.

31. The game method of claim 28, further comprising one of:
displaying the pre-defined image sequence to the user temporarily during game play;
displaying the pre-defined image sequence to the user during the entire game play; and
displaying the pre-defined image sequence to the user temporarily before start of the game play.
